(19) United States
(12) Patent Application Publication
(10) Pub. No.: US 2003/0103482 A1
(43) Pub. Date: Jun. 5, 2003

(54) Method of enabling communication with a wireless communication device

(76) Inventor: James A. Van Bosch, Crystal Lake, IL (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/004,669

(22) Filed: Dec. 4, 2001

(51) Int. Cl. H04Q 7/24

(52) U.S. Cl. 370/338; 370/349

(57) ABSTRACT

A method of enabling communication with a wireless communication device is described. The method comprises steps of storing a unique identifier of the wireless communication device in a memory of a second wireless communication device; providing the unique identifier of the wireless communication device from the second wireless communication device to a wireless communication network; and communicating with the wireless communication device based upon its dynamic address.

### FIELD OF THE INVENTION

The present invention relates to wireless communication devices, and more particularly to a method for enabling communication with a wireless communication device.

### BACKGROUND OF THE INVENTION

As wireless communication networks continue to evolve, new applications for data and new channels for providing data to individuals continue to be developed. One recent application for data can be found in the area of telematics. Telematics is a term generally related to the provisioning of data and/or services to vehicles. As the needs of users of vehicles and the capabilities of telematics systems continue to evolve, the uses for sending packet data have also increased.

Further, wireless devices are being developed to receive data via a packet switched network using static or dynamic IP addressing. For example, new telematics systems and other wireless communication devices, such as cellular telephones and personal digital assistants having wireless capability, are being designed with packet data capabilities. Further, the majority of network operators are beginning to deploy dynamic IP addressing schemes for these devices.

However, unlike conventional circuit switch networks which can easily locate a wireless communication device, a wireless communication device which is assigned a dynamic address, such as a dynamic internet protocol (IP) address, may not be located except by the network that assigned the dynamic IP address. If a wireless communication device is assigned a dynamic IP address, it would only be possible to communicate with the wireless communication device if the current dynamic IP address of the wireless communication device is known.

Accordingly, there is a need for a method for communicating with a wireless communication device having a dynamic IP address.

### DESCRIPTION OF THE DRAWINGS

FIG. 1 is a system level diagram of a wireless communication network for implementing a method of the present invention;

FIG. 2 is a system level diagram of an alternate embodiment of a wireless communication network for implementing a method of the present invention;

FIG. 3 is a system level diagram of a further alternate embodiment of a wireless communication network for implementing a method of the present invention;

FIG. 4 is a block diagram of a central server according to the present invention;

FIG. 5 is a block diagram of a wireless communication device according to the present invention;

FIG. 6 is a flow chart showing a method for enabling communication with a wireless communication device from a vehicle according to the present invention;

FIG. 7 is a flow chart showing a method for enabling communication with a wireless communication device coupled to a vehicle according to the present invention;

FIG. 8 is a method for enabling communication between a communication device and a wireless communication device coupled to a vehicle according to the present invention;

FIG. 9 is a flow chart showing a method for enabling communication with a wireless communication device according to an alternate embodiment of the present invention;

FIG. 10 is a method for storing information for contacting a wireless communication device according to the present invention; and

FIG. 11 is a flow chart showing a method for enabling communication with a wireless communication device having a mobile tagging feature according to the present invention.

### DESCRIPTION OF THE PREFERRED EMBODIMENTS

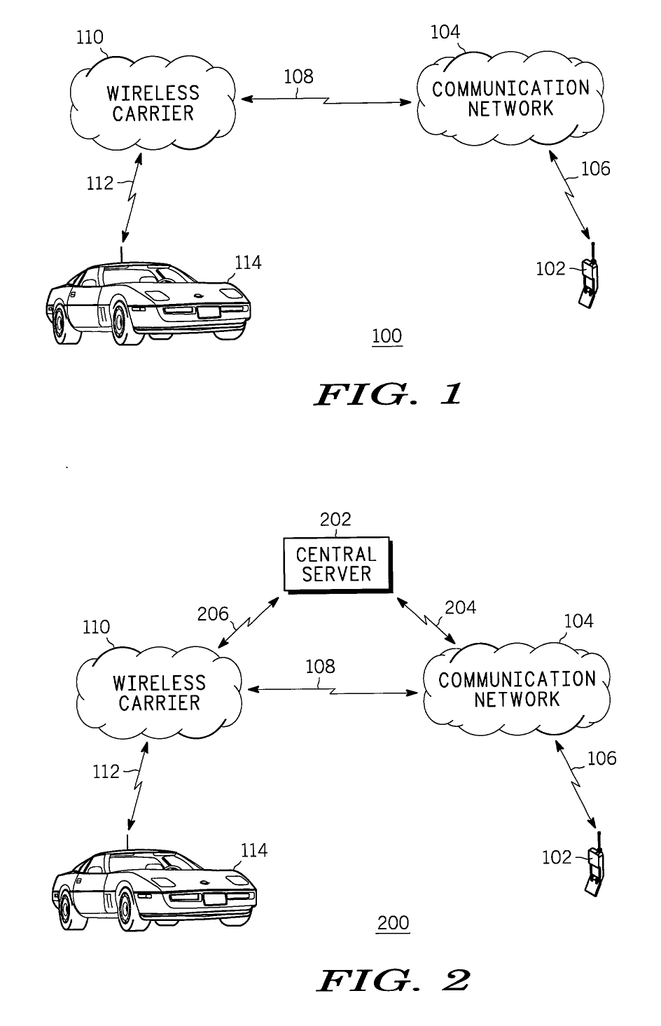

Turning first to FIG. 1, a system level diagram of a network for enabling communication with a wireless communication device according to the present invention is shown. In particular, a communication network 100 preferably comprises a communication device 102 which is adapted to communicate with a communication network 104 by way of a communication link 106. The communication device 102 could be a wireless communication device, such as a cellular telephone, a pager, or a personal digital assistant (PDA) having wireless capability, or a conventional wire line device, such as a conventional telephone or a computer connected to a wire line network. Similarly, the communication network 104 could be any type of communication network, such as a circuit switched network. In particular, it could be a land line communication network or a wireless communication network, both of which are well known in the art. A data connection 108 enables communication between the communication network 104 and a wireless carrier 110. The data connection 108 could be any type of data connection, such as circuit switched, paging, SMS, packet data, etc.

A second communication link 112 enables communication to a second wireless communication device 114. The second wireless communication device 114 is preferably a telemetics communication unit installed in a vehicle. Most current telematics systems include a wireless communication device embedded within the vehicle for accessing the telematics service provider. For example, conventional telematics units include a cellular telephone transceiver to enable communication between the vehicle and a call center associated with telematics service for the vehicle. The vehicle could have a handset coupled to the wireless communication device, and/or include hands free functionality within the vehicle. Alternatively, a portable phone operated by the user could be coupled to a “cradle” which enables communication between the portable device and the wireless communication device of the telematics system. The cradle could enable synchronization between the portable and the wireless communication device of the vehicle. Preferably, the wireless carrier 110 enables the transmission of packet data to the second wireless communication device 114.

As will be described in more detail with respect to the remaining figures, the methods of the present disclosure enable the location of and transfer of data to a communication device having a temporary or dynamic address, such as a dynamic IP address, for locating the device. Also, while separate communication networks are shown, the data connection 108 could be between elements of a single communication network. Also, communication device 102 and wireless communication device 114 could be any type of communication device having a temporary or changing IP address, with at least one device in the network having a dynamic address. Finally, both one directional and two directional communication for providing packet data information could be employed between two devices. That is, in any case where packet data is transmitted in one direction, it is envisioned that data could also be transmitted in the opposite direction.

Turning now to FIG. 2, a system level diagram for enabling communication with a wireless communication device according to an alternate embodiment of the present invention is shown. In particular, the communication system 200 of FIG. 2 further includes a central server 202. The central server could be, for example, a telematics service provider having conventional call center capability operated by employees, or voice recognition (VR) systems, as is well known in the art. The central server preferably communicates with the communication network 104 by way of a data connection 204, and with the wireless carrier 110 by way of a data connection 206. The central server 202 preferably includes a memory for storing address information, a unique identifier, the registration status or other information associated with one or more communication devices, such as a dynamic IP address for a wireless communication device.

Although separate communication networks (i.e. communication network 104 and wireless carrier 110) are shown, a communication network could be employed with the central server 202 communicating with various elements of the communication network. Similarly, although only two wireless communication devices are shown, multiple communication devices, whether associated with wired or wireless network, could be employed.

As will be described in more detail in reference to the remaining figures, only one of the communication devices 102 or 114 may be required to communicate directly with the central server 202. That is, one of the communication devices 102 or 114 may receive the necessary dynamic address for the other communication device by way of either the data connection 204 or the data connection 206, and communicate directly with the other communication device by way of the data connection 108 using the dynamic address received from the central server 202. Finally, although the central server 202 is shown separate from any communication network, the central server 202 could be employed in a communication network or by a service provider associated with a communication network.

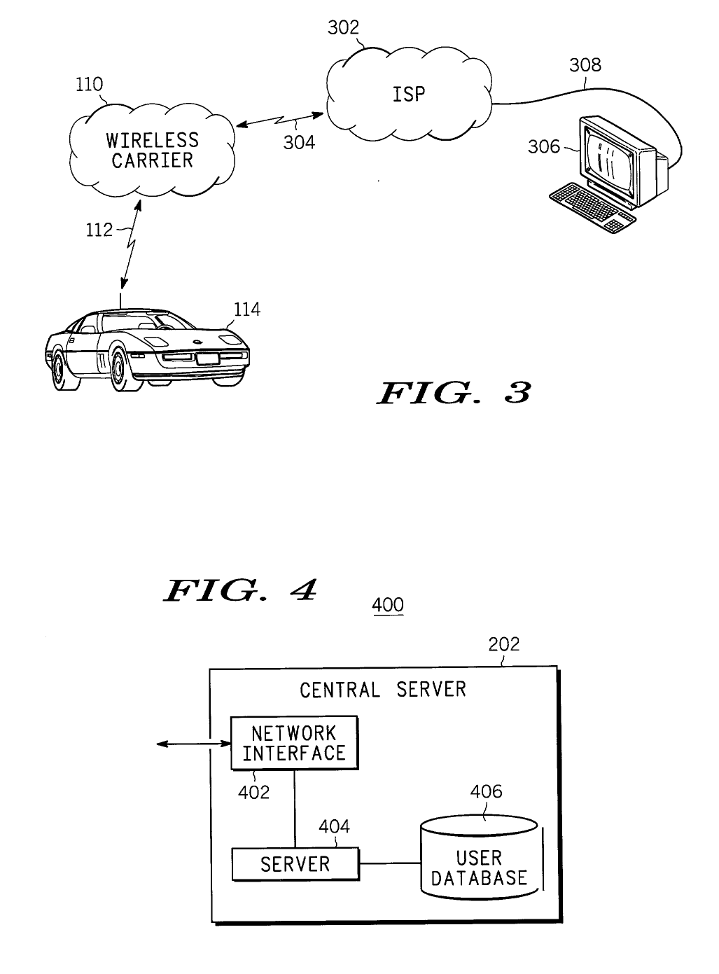

Turning now to FIG. 3, a communication system for enabling communication with a wireless communication device according to an alternate embodiment of the present invention is shown. In particular, an Internet Service Provider (ISP) 302 enables communication with the wireless communication device 114 by way of a data connection 304. A user of a terminal 306 is coupled to the ISP 302 by way of a communication link 308. The terminal 306 could be any type of communication device, including wired communication devices or wireless communication devices coupled to the ISP 302. For example, the terminal 306 could be a cellular telephone, pager, PDA or laptop having wireless capability, or a wired device, such as a computer or other device capable of communicating with the ISP 302.

As will be described in more detail in reference to the remaining figures, the Internet service provider 302 could enable the transfer of information from the terminal 306 to the wireless communication device 114 by a packet data connection, or the wireless communication 114 could communicate with the terminal 306 by way of the Internet service provider 302 to receive an address, such as a dynamic IP address, to contact a separate communication device.

Turning now to FIG. 4, a block diagram of a central server 400, such as the central server 202, is shown. In particular, a network interface 402 enables communication with a communication network, such as communication network 104, wireless carrier 110, or Internet service provider 302. The network interface 402 is coupled to a server 404. A user data base 406 is also coupled to the server 404 and stores information related to users. For example, the user data base could comprise a memory for storing one or more temporary addresses, authentication information, a unique identifier, a registration status, or other information associated with one or more devices of a user.

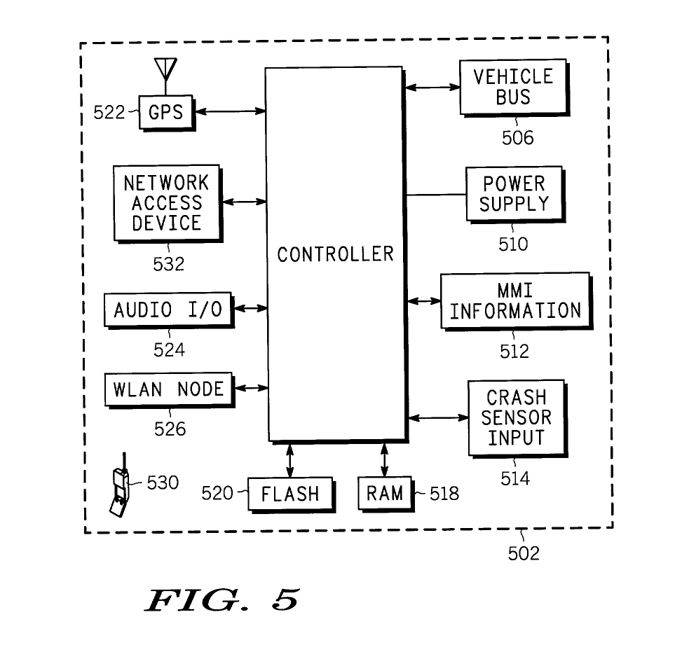

Turning now to FIG. 5, a block diagram of a telematics communication system according to the present invention is shown. The telematics unit 502 preferably comprises a controller 504 having various input/output (I/O) ports for communicating with various components of the vehicle. For example, the controller 504 is coupled to a vehicle bus 506, a power supply 510, a man machine interface (MMI) 512, and a crash sensor input 514. The connection to the vehicle bus enables operations such as unlocking the door, sounding the horn, flashing the lights, etc. The controller 504 is also preferably coupled to various memory elements, such as a random access memory (RAM) 518 or a flash memory 520. The telematics system 504 also preferably includes a global positioning system (GPS) unit 522 which provides the location of the vehicle, as is well known in the art. The controller 504 is also preferably coupled to an audio I/O 524 which preferably includes a hands free system for audio communication for a user of the vehicle by way of a wireless communication network, such as a cellular telephone network.

Finally, the telematics unit 502 could include a wireless local area network node 526 which is also coupled to the controller and enables communication between a WLAN enabled device such as a cellular telephone and the controller 504 by way of a WLAN communication means. Using a portable cellular telephone as the wireless communication device for the telematics unit eliminates the need for a separate cellular transceiver in the vehicle, thereby reducing cost of the telematics unit. A WLAN device could communicate with the WLAN enabled controller 504 by any WLAN protocol, such as Bluetooth, IEEE 802.11, IrdA, or any other WLAN application. However, the portable cellular telephone could communicate with the controller by any means known in the art.

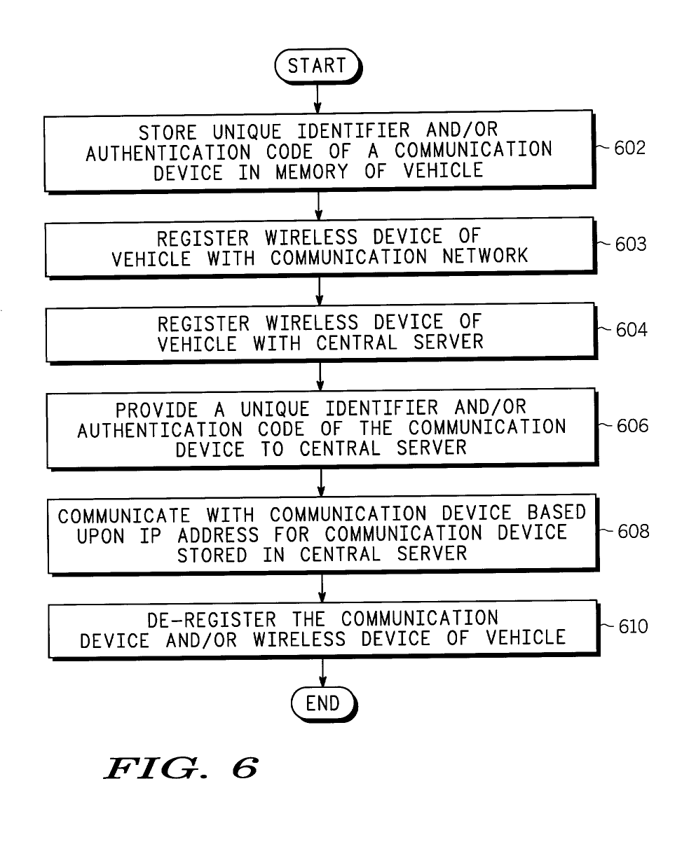

Turning now to FIGS. 6-11, methods are shown for enabling communication with a wireless communication device on the communication system shown in FIGS. 1-3 and/or using the devices in FIGS. 4-5, or using other communication equipment. Referring first to FIG. 6, a flow chart shows a method for enabling communication with a wireless communication device from a vehicle. In particular, a unique identifier and/or authentication code of a wireless communication device is stored in a memory of a vehicle at a step 602. The unique identifier of the mobile wireless communication device could be, for example, an electronic serial number (ESN) or an International Mobile Subscriber Identity (IMSI). Storing the unique identifier or other information prevents a driver from having to enter the information from the vehicle each time the wireless communication device is contacted.

The wireless communication device of the vehicle registers with a communication network, at which time it is assigned a dynamic IP address at a step 603. The wireless device of the vehicle also registers with a central server at a step 604. The central server could be reached by a static IP address or by a domain name system (DNS) service which is well known in the art. Accordingly, the vehicle can locate and register with a central server by its known IP address or domain name stored in the vehicle, when manufactured for example. The central server preferably authenticates the vehicle for access, or optionally includes a communication link which is encrypted. The dynamic IP address of the wireless communication device of the vehicle, and a unique identifier and/or authentication code of the wireless communication device to be called are provided to the central server at a step 606. It is then possible for the wireless communication device of the vehicle to communicate with the wireless communication device to be called using a data communication link based upon the IP for the wireless communication device to be called stored in the central server at a step 608. The central server preferably includes a look-up table having a dynamic address stored with unique identifier information and authentication codes for wireless communication devices. Further, whenever a device registers with a server, the server can use the stored IP address of the originating device communicating with it to send an acknowledgment or error code to the originating device.

The wireless communication device and/or the wireless communication device of the vehicle can then de-register at a step 610. De-registration enables a communication system to provide faster feedback to a calling device. That is, if the called device is not on or within range of its communication system, the calling device can be informed immediately, rather than waiting for a predetermined time before the called device has failed to answer. In addition, the server can periodically poll the device to determine if the device is currently registered, such as the periodic location update function which is well known in GSM systems. The wireless communication device of the vehicle could communicate directly with called wireless communication device, as shown for example in the embodiment of FIG. 1, or could communicate through the central server as shown for example in the embodiment of FIG. 2. Although a central server is described, a server could be located within a given communication network or external to a communication network.

One practical application of the method of FIG. 6 could include a vehicle providing an alert to the wireless communication device that a vehicle's alarm has been activated. The wireless communication device of the vehicle could contact a server via a packet data connection. The vehicle could then transfer the ESN and the authentication code of the wireless communication device which it desires to call to the server. The wireless communication device of the vehicle could also transfer a message type and optional control/data for the called wireless communication device.

Upon successful authentication to the server, the server looks in its table for a ESN of the called wireless communication device and the corresponding current IP address associated with the ESN. If the ESN is located, the central server will contact the called wireless communication device based upon the stored current IP address and authenticate access to the mobile. If the authentication fails, an error code is preferably returned to the vehicle using the dynamic IP of the wireless communication device of the vehicle.

Upon successful authentication to the called wireless communication device, the central server will then transfer control/data information to the called wireless communication device. The called wireless communication device will then process the message and perform the indicated operation. If the authentication is unsuccessful, an error code will be sent back to the wireless communication device of the vehicle. Optionally, the called wireless communication device can send back to the server a status message or acknowledgment, such as a message indicating that the control/data information was successfully received by the called wireless communication device.

Alternatively, the vehicle could contact the mobile directly, rather than through a central server. The wireless communication device of the vehicle preferably contacts a central server via a packet data connection, and transfers the ESN of the wireless communication device that it is trying to contact, and any authentication code, message type or optional control/data. If the authentication fails, an error code is preferably returned to the vehicle. However, upon successful authentication to the central server, the central server looks in its table for a corresponding ESN and the IP address or addresses associated with that ESN. When a match is found, the central server provides the IP address to the wireless communication device of the vehicle. The wireless communication device of the vehicle then contacts the wireless communication device directly via the IP address provided by the server.

In particular, the wireless communication device of the vehicle then contacts the wireless communication device and attempts to authenticate using the authentication code for the wireless communication device stored in a memory of the vehicle, such as in a non-volatile memory associated with the wireless communication device of the vehicle. Upon successful authentication, the wireless communication device of the vehicle then transfers the control/data information and optionally its dynamic IP address to the called wireless communication device. The called wireless communication device then processes the message and performs the indicated operation, as necessary. If the authentication is unsuccessful, however, an error code will be sent back to the vehicle. The wireless communication device could also transfer a status message or acknowledgment based upon the dynamic IP address of the wireless communication device of the vehicle.

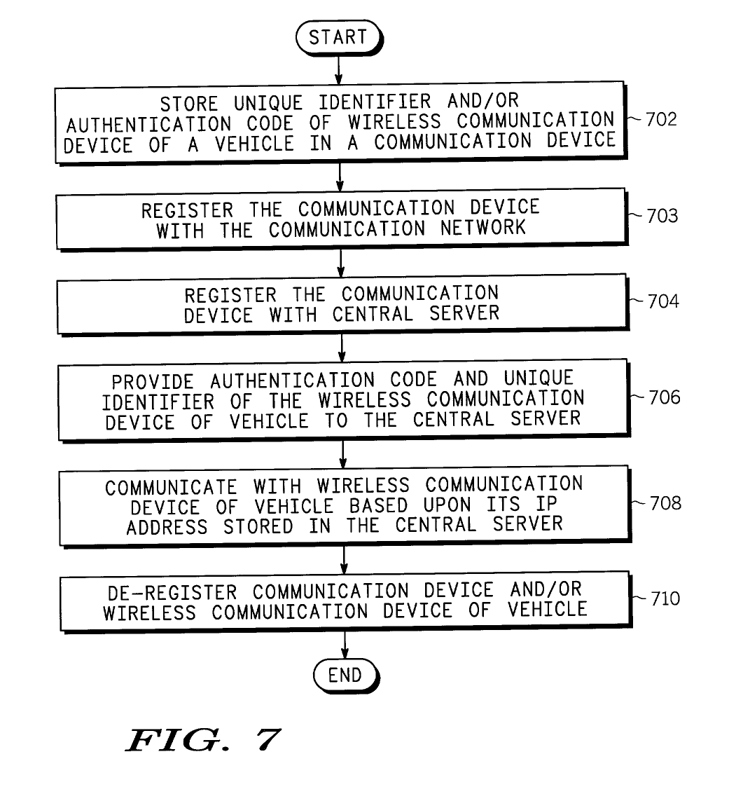

Turning now to FIG. 7, a flow chart shows a method for enabling communication with a wireless communication device in a vehicle. In particular, a unique identifier and/or authentication code of a wireless communication device of a vehicle is stored in a calling communication device at a step 702. A wireless communication device registers with a wireless communication network at which time it is assigned a dynamic IP address at a step 703. The calling communication device then registers with the central server at a step 704. The dynamic IP address of the calling communication device, and authentication and a unique identifier of the wireless communication device of the vehicle are provided by the calling communication device to the central server at a step 706. The unique identifier of the wireless communication device of the vehicle could be, for example, the vehicle identification number (VIN) or an ESN of the wireless communication device of the vehicle. It is then possible for the calling communication device to communicate with the wireless communication device of the vehicle based upon the current IP address for the vehicle's wireless communication device stored in the central server at a step 708. The calling communication device and/or the wireless communication device of the vehicle can then de-register at a step 710.

Although the method of FIG. 7 finds particular application in contacting a wireless communication device integrated in a vehicle, such as a telemetics unit, the method of FIG. 7 can be employed to contact any wireless communication device having a dynamic identifier, such as a dynamic IP address. Similarly, the wireless communication device could be contacted by any type of device, such as another wireless communication device, or a fixed communication device or other terminal, such as a computer.

One practical application for the method of FIG. 7 is the control of the vehicle by sending a command from a device to a wireless communication device of the vehicle using a packet data connection. For example, the calling communication device could contact a server via a packet data connection. The device could transfer the VIN, an authentication code, message type and optional control/data for the vehicle it is trying to contact. If the authentication to the server is successful, the server determines whether it has an IP address for the corresponding VIN provided by the calling communication device. If the server has a current IP address, the server will contact the vehicle via the IP address and authenticate access to the vehicle. Upon successful authentication to the vehicle, the central server will transfer the control/data information to the vehicle. The vehicle will then process the message and perform the indicated operation. For example, the message could include a command to start the vehicle, deactivate an alarm, or perform some other function of the vehicle. If the authentication to the mobile is unsuccessful, an error code will be sent back to the wireless communication device via the server. Finally, the vehicle could optionally transfer a status message or acknowledgment if the command was successful.

Alternatively, the central server could provide the current IP address of the wireless communication device of the vehicle to the calling wireless communication device, enabling the calling wireless communication device to attempt to contact the vehicle directly. For example, the calling wireless communication device could then transfer information via a packet data connection, such as transferring an MP3 file to the vehicle. Such a transfer would reduce the load on the central server in cases where large amounts of data is to be transferred.

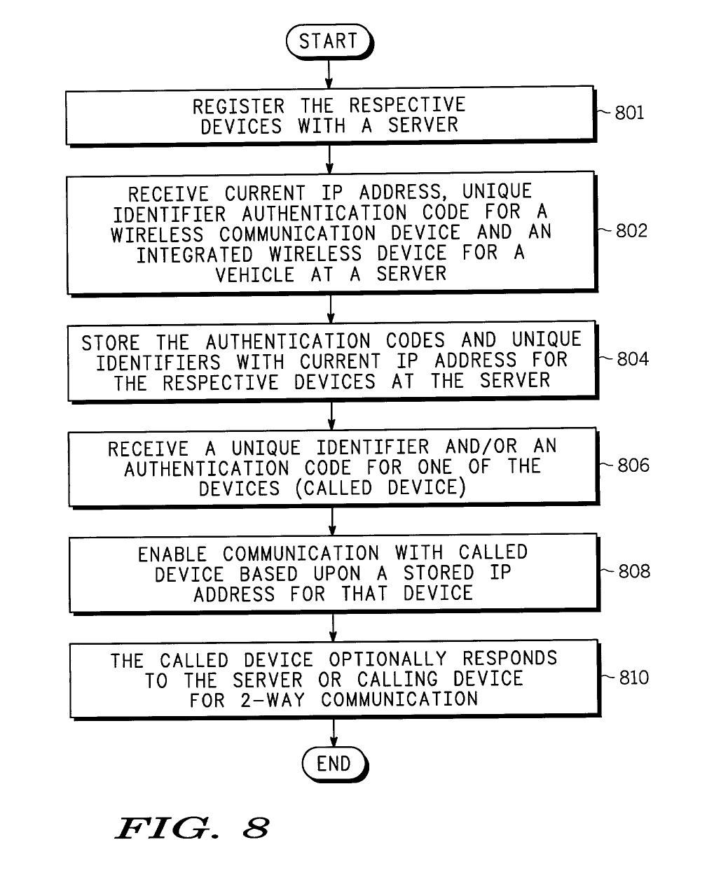

Turning now to FIG. 8, a flow chart shows a method for enabling communication between a wireless communication device and a vehicle having an integrated wireless communication device. If two devices in a communication network attempt to communicate with each other, the central server can enable communication between the two devices using a packet data connection. The devices register with their respective communication networks at a step 801, at which time they are provided dynamic IP addresses. Unique identifiers and/or authentication codes for a wireless communication device and an integrated wireless communication device in a vehicle are received at a central server at a step 802. The dynamic IP addresses, unique identifiers and authentication codes are stored with current IP addresses for the respective devices at the central server at a step 804. A unique identifier and authentication code for one of the devices (the called device) is received at the server at a step 806. The central server then enables communication with the called device based upon a stored IP address for that device at a step 808. That is, the server provides the current IP address of the device to the calling device, or simply communicates directly with the called device. The called device may optionally respond to the server or the calling device at a step 810, thereby enabling bidirectional communication between the two devices. That is, the called device could respond to the server, or could respond directly to the calling device if the dynamic IP address of the calling device is provided to the called device by the server.

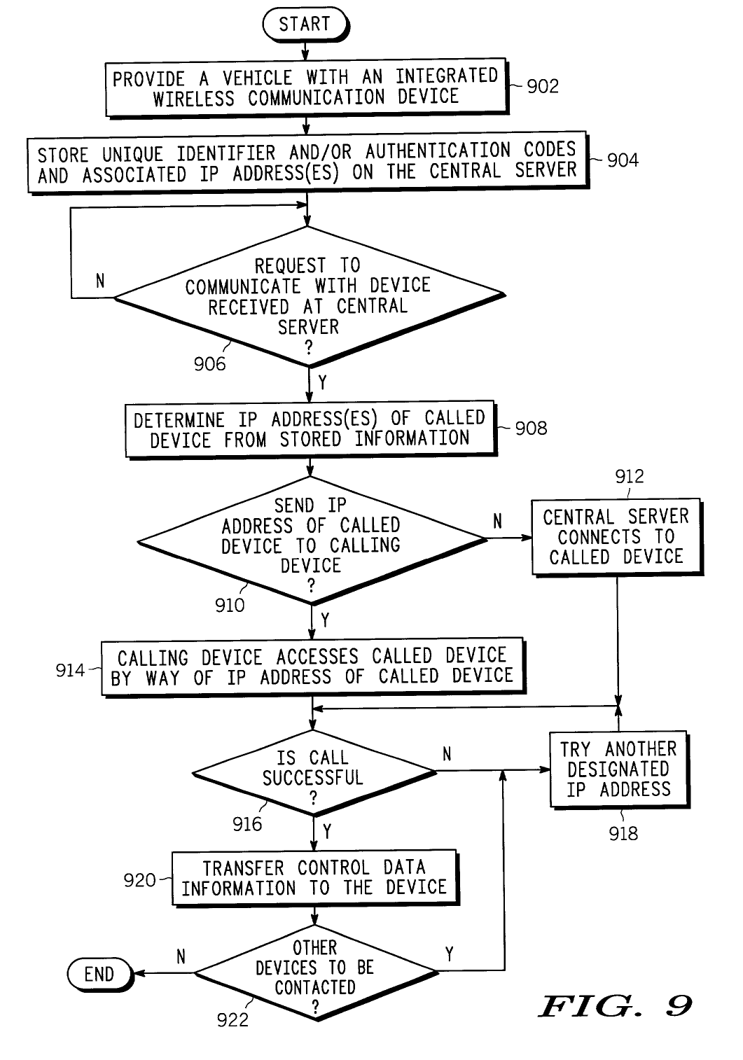

Turning now to FIG. 9, a flow chart shows a method for enabling communication with a wireless communication device according to the present invention. In particular, a vehicle is provide with an wireless communication device at a step 902. For example, such a device could be a telematics communications unit which could operate on a cellular system as is well known in the art. Unique identifiers and/or authentication codes and associated IP addresses are stored on the central server at a step 904. This information could include identifiers and codes for the wireless communication device of the vehicle, or other wireless communication devices which may be associated with a user of the vehicle.

It is then determined whether a request to communicate with a wireless communication device is received at the central server at a step 906. If a request is received, the IP address or addresses of the called wireless communication device is then determined from the stored information at a step 908. It is then determined whether the IP address of the called device should be sent to the calling device at a step 910. If not, the central server contacts the called device directly. Alternatively, the calling device accesses the called device by way of the IP address of the called device provided from the central server at a step 914.

It is then determined whether the call is successful. If the connection is not successful, the calling device will try another designated IP address at a step 918. If the call is successful, the calling device will transfer control/data information to the device at a step 920. Finally, it is then determined whether other devices are to be contacted at a step 922. For example, a user of a wireless communication device may have a list of devices which should be contacted for particular messages. If other devices are to be provided with the control/data information, then another designated IP address will be contacted at step 918.

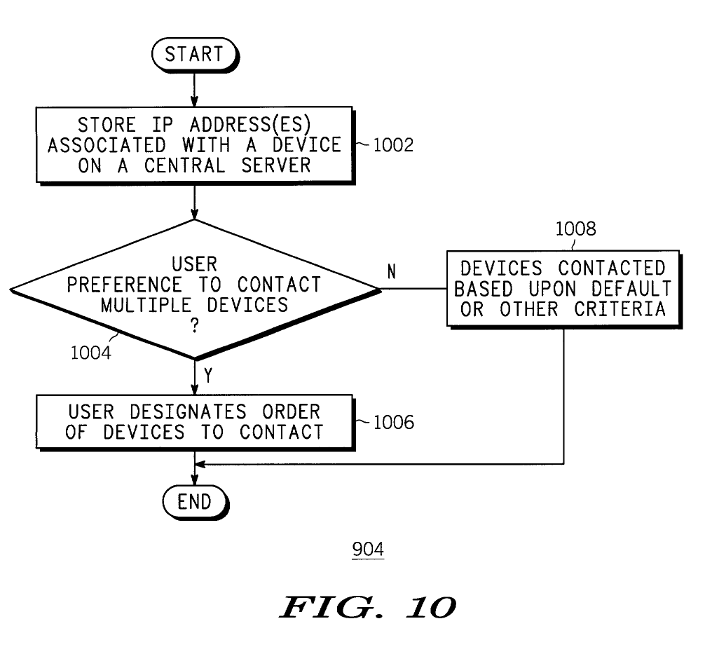

Turning now to FIG. 10, a flow chart shows a method for storing authentication codes and/or unique identifiers and associated IP addresses on a central server as shown at step 904 of FIG. 9. In particular, IP addresses associated with a device are stored on a central server at a step 1002. As set forth above, the user could set preferences to contact various devices. Such preferences could include the order to contact devices, desire to contact certain devices for certain messages, the desire to continue to contact additional devices even if a device is reached, etc. It is then determined whether a user has a preference to contact multiple devices at a step 1004. If the user has a preference, the user designates the order of the devices to contact at a step 1006. The user may also designate whether the devices should be contacted until one device acknowledges receiving the message, or whether all devices should be contacted. If the user does not have a preference regarding contacting multiple devices, the devices are preferably contacted based upon default or some other criteria at a step 1008. For example, the devices could be contacted based upon the most frequently used devices, such as based upon the amount of time it is registered with the network, or some other criteria.

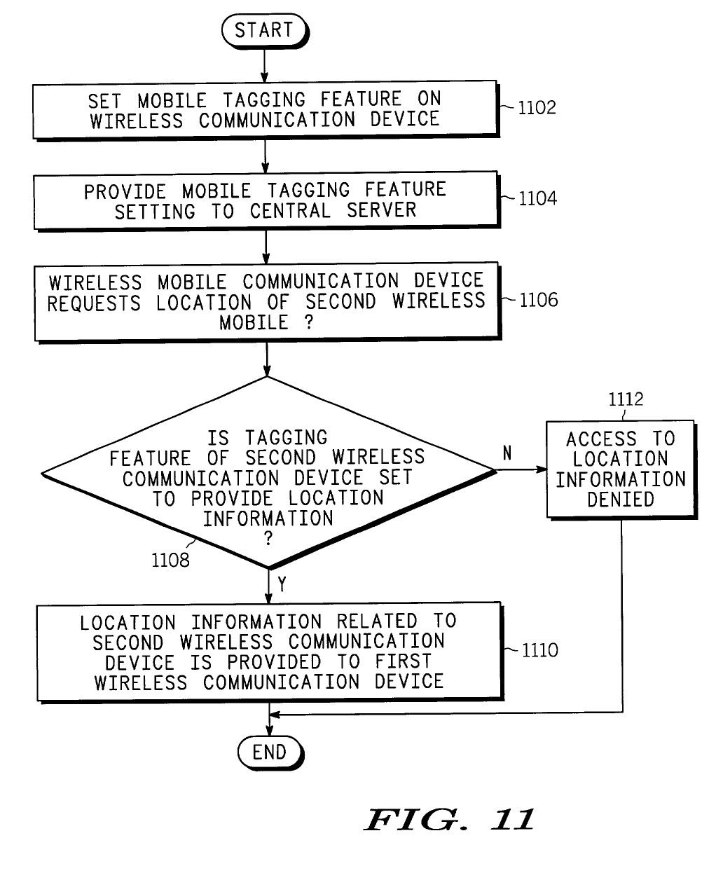

Turning now to FIG. 11, a method for enabling communication with a wireless communication device having a tagging feature is shown. The tagging feature would generally enable tracking of a user of a wireless communication device. The arrival of various location services and the requirement by government agencies to provide location information will enable convenient features for wireless communication devices, as well as other wireless devices such as telemetics units installed in vehicles.

In particular, a tagging feature on a wireless communication is set at a step 1102. The tagging feature setting is provided to a central server at a step 1104. A communication device, such as another mobile wireless communication device, requests the location of a second wireless communication device at a step 1106. It is then determined whether the tagging feature of the second wireless communication device is set to provide location information at a step 1108. If the tagging feature of the second wireless communication device is set to provide location information, the central server provides the location information related to the second wireless communication device to the first wireless communication device. The information could be sent directly to the requesting device using an IP address of the requesting device at a step 1110. Alternatively, location information could be provided from the server to the second wireless communication device. However, if the tagging feature of the second wireless communication device is not set to provide location information, access to the location information is denied at a step 1112.

It can therefore be appreciated that a new and novel method for enabling communication with a wireless communication device has been described. It will be appreciated by those skilled in the art that, given the teaching herein, numerous alternatives and equivalent will be seen to exist which incorporate the disclosed invention. As a result, the invention is not to be limited by the foregoing exemplary embodiments, but only by the following claims.

We claim:

1. A method of enabling communication with a wireless communication device, said method comprising the steps of:
assigning a dynamic address to said wireless communication device when said wireless communication device registers with a wireless communication network;
storing a unique identifier of said wireless communication device in a memory of a second communication device;
providing said unique identifier of said wireless communication device from said second communication device to a server; and
communicating with said wireless communication device based upon said dynamic address assigned to said wireless communication device.

2. The method of claim 1 wherein said step of assigning a dynamic address to said wireless communication device when said wireless communication device registers with a wireless communication network comprises assigning a dynamic IP address to a wireless communications device coupled to a vehicle.

3. The method of claim 1 wherein said step of storing a unique identifier of a wireless communication device in a memory of a second communication device comprises storing a VIN of a vehicle in said memory of said second wireless communication device.

4. The method of claim 1 wherein said step of storing a unique identifier of a wireless communication device in a memory of a second communication device comprises storing an electronic serial number in said memory of said second wireless communication device.

5. The method of claim 1 wherein said step of storing a unique identifier of a wireless communication device in a memory of a second communication device comprises storing an electronic serial number of a wireless communication device of a vehicle in said memory of said second wireless communication device.

6. The method of claim 1 wherein said step of storing a unique identifier of a wireless communication device in a memory of a second communication device comprises storing an electronic serial number of said wireless communication device in a memory of a wireless communication device coupled to a vehicle.

7. The method of claim 1 wherein said step of providing said unique identifier of said wireless communication device to a server comprises providing an electronic serial number to a cellular service provider.

8. The method of claim 1 wherein said step of providing said unique identifier of said wireless communication device to a server comprises providing a VIN to a cellular service provider.

9. The method of claim 1 further comprising a step providing a command from said wireless communication network to said wireless communication device.

10. The method of claim 9 wherein said step of communicating with said wireless communication device based upon said dynamic address assigned to said wireless communication device comprises controlling a vehicle coupled to said wireless communication device.

11. The method of claim 1 wherein said step of communicating with said wireless communication device based upon said dynamic address assigned to said wireless communication device comprises providing packet data to said wireless communication device coupled to a vehicle based upon a dynamic IP address assigned to said wireless communication device.

12. The method of claim 1 wherein said step of communicating with said wireless communication device comprises providing a command from said wireless communication network to said wireless communication device coupled to a vehicle.

13. The method of claim 1 further comprising a step providing said dynamic address to said second communication device.

14. The method of claim 13 wherein said step of communicating comprises providing a command from said second communication device to said wireless communication device based upon said dynamic address assigned to said wireless communication device.

15. A method of enabling communication with a wireless communication device, said method comprising the steps of:
storing a unique identifier of said wireless communication device coupled to a vehicle in a memory of a second wireless communication device;
providing said unique identifier of said wireless communication device coupled to a vehicle from said second wireless communication device to a wireless communication network; and
communicating with said wireless communication device coupled to a vehicle based upon a dynamic address associated with said wireless communication device coupled to a vehicle.

16. The method of claim 15 further comprising a step of assigning a dynamic address to said wireless communication device coupled to a vehicle when said wireless communication device registers with a wireless communication network.

17. The method of claim 15 wherein said step of storing a unique identifier of a wireless communication device coupled to a vehicle in a memory of a second wireless communication device comprises storing a VIN of said vehicle in a memory of a second wireless communication device.

18. The method of claim 15 wherein said step of providing said unique identification of said wireless communication device to a communication network comprises providing a VIN to a cellular service provider.

19. The method of claim 15 further comprising a step providing a command from said wireless communication network to said wireless communication device.

20. The method of claim 15 wherein said step of communicating with said wireless communication device based upon said dynamic address associated with said wireless communication device comprises controlling a vehicle incorporating said wireless communication device.

21. The method of claim 15 wherein said step of communicating with said wireless communication device based upon a changeable address associated with said wireless communication device comprises providing packet data to said wireless communication device coupled to a vehicle based upon a dynamic IP address assigned to said wireless communication device coupled to a vehicle.

22. The method of claim 15 wherein said step of communicating comprises providing a command from said wireless communication network to said wireless communication device.

23. The method of claim 15 further comprising a step providing said dynamic address to said second communication device.

24. The method of claim 23 wherein said step of communicating comprises providing a command from said second communication device to said wireless communication device.

25. A method of enabling communication with a wireless communication device, said method comprising the steps of:
storing a unique identifier of said wireless communication device in a memory of a second wireless communication device coupled to a vehicle;
providing said unique identifier of said wireless communication device stored in said second wireless communication device to a wireless communication network; and
enabling communication to said wireless communication device based upon a dynamic address associated with said wireless communication device.

26. The method of claim 25 further comprising a step of assigning said dynamic address to said wireless communication device when said wireless communication device registers with said wireless communication network.

27. The method of claim 25 wherein said step of storing a unique identifier of a wireless communication device in a memory of a second wireless communication device comprises storing an ESN of said wireless communication device in a memory of a second wireless communication device.

28. The method of claim 25 wherein said step of providing said unique identifier of said wireless communication device to a wireless communication network comprises providing an electronic serial number to a cellular service provider.

29. The method of claim 25 wherein said step of providing said unique identifier of said wireless communication device to a wireless communication network comprises providing a VIN to a cellular service provider.

30. The method of claim 25 further comprising a step providing a command from said wireless communication network to said wireless communication device.

31. The method of claim 25 further comprising a step providing information from said wireless communication network to said wireless communication device.

32. The method of claim 25 wherein said step of enabling communication with said wireless communication device based upon a dynamic address associated with said wireless communication device comprises providing packet data to said wireless communication device.

33. The method of claim 25 wherein said step of enabling communication with said wireless communication device comprises providing a command from said wireless communication network to said wireless communication device.

34. The method of claim 25 further comprising a step providing said dynamic address to said second wireless communication device.

35. The method of claim 34 wherein said step of communicating comprises providing a command from said second wireless communication device to said wireless communication device based upon said dynamic address.
